(19) United States
(12) Patent Application Publication
(10) Pub. No.: US 2004/0140139 A1
(43) Pub. Date: Jul. 22, 2004

(54) Hybrid drive

(76) Inventor: Manfred Malik, Penzberg (DE)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025, US

(21) Appl. No.: 10/723,134

(22) Filed: Nov. 26, 2003

(30) Foreign Application Priority Data
Nov. 27, 2002 (EP) 02 026 534.4

(51) Int. Cl. B60K 1/00

(52) U.S. Cl. 180/65.2

(57) ABSTRACT

A hybrid drive system includes a combustion engine, an electric machine, a short-time storage device and a long-time storage device. The combustion engine and the electric machine are mechanically coupled. They jointly apply a drive torque to a drive when high performance is required. The long-time storage and the short-time storage are charged with different charging voltages, whereby the charging voltage of the long-time storage is lower than that of the short-time storage. Both storage devices are coupled by an electric valve in such a way that, upon a supply of power to the electric machine, the electric machine is initially only supplied from the short-time storage, thus reducing the voltage of the short-time storage. When the voltage of the short-time storage equals or drops below the voltage of the long-time storage, the electric valve connects the short-time storage in parallel.

### CROSS-REFERENCE TO RELATED APPLICATIONS

The present patent application claims priority from European Patent Application No. 02 026 534.4, filed Nov. 27, 2002.

### FIELD

Embodiments of the invention generally concern a hybrid drive and, for example, hybrid drive systems and methods for a joint application of a drive torque.

### BACKGROUND

A hybrid drive system comprising a combustion engine and an electric machine is known from EP 0 847 487 B1. Said systems are mechanically connected and apply a drive torque to the drive when high performance requirements are needed. In other words, the electric machine operates as a “booster” supporting the combustion engine during acceleration, for example. The electric machine also serves as a starter for the combustion engine. The drive system comprises a short-time storage and a long-time storage charged with different charging voltages, i.e., the charging voltage of the long-time storage is lower than that of the short-time storage. The power supply of the electric machine is generated by the short-time storage.

Publication DE 197 09 298 A1 describes a hybrid drive system, whereby a long-time storage and a short-time storage are also charged with different charging voltages, and the charging voltage of the long-time storage is lower than that of the short-time storage. Both storage devices are connected with a bi-directional converter serving as a down converter inside the long-time storage when supplying energy, and as an up converter when drawing energy. When starting the combustion engine, the electric machine is not only powered by the short-time storage, but mainly by simultaneously drawing energy from both storage devices, whereby the booster increases the energy drawn from the long-time storage to the higher voltage level of the short-time storage.

U.S. Pat. No. 5,818,115 describes an internal circuitry for a starter of a combustion engine, whereby a capacitor and a battery may be connected in parallel by means of a switch, e.g., in form of a thyristor. When the switch is opened, the engine is normally only started from the capacitor. When the capacitor is insufficiently charged, the switch is obviously closed before starting the engine, and it is started by connecting the capacitor and the battery in parallel.

Publication JP 2001123923 A describes another internal circuitry powering a starter, whereby a battery and a capacitor collaborate when supplying the power required for starting the engine. Both are connected in parallel, i.e., are charged with the same charging voltage, and simultaneously deliver the stored energy when starting the engine. A diode switched between the battery and the capacitor keeps the energy stored in the capacitor from flowing back in the battery circuit.

Publication DE 197 52 661 C2 describes yet another internal circuitry powering a starter-generator, whereby a battery works together with a capacitor by means of an up converter and a diode when supplying the voltage required for starting the engine. Additional energy is drawn from the up converter when the voltage of the capacitor drops below the output voltage of said up converter.

U.S. Pat. No. 6,075,331 describes a drive system, e.g., for an electric vehicle. FIG. 3 of said patent shows an embodiment comprising a battery and a capacitor storage connected by means of an up converter, which convert the lower voltage of the battery into a higher voltage in order to supply energy to the electric drive motor. A diode switched between the battery and the capacitor storage only allows a limited voltage to go through. It serves as a slower charging means of the capacitor when the voltage of said capacitor has dropped below the battery voltage; the power supply of the electric drive motor, on the other side, flows through the up converter.

An article written by H. Michel and published in the magazine “Elektronik” of Jan. 22, 2002 under the title “Large . . . , Maxi . . . , UltraCap” describes an internal circuitry, whereby a combustion engine is started by means of a battery and a capacitor in the form of an UltraCap, and both connected in parallel.

### SUMMARY

Following a first aspect, embodiments of the present invention concern a hybrid drive system comprising a combustion engine, an electric machine, a short-time storage device, and a long-time storage device. The combustion engine and the electric machine are mechanically coupled and arranged to jointly apply a drive torque to a drive when high performance is required. The drive system is arranged such that the long-time storage and the short-time storage are charged with different charging voltages, whereby the charging voltage of the long-time storage is lower than that of the short-time storage. The short-time storage and the long-time storage are coupled by an electric valve in such a way that, upon a supply of power to the electric machine, the electric machine is initially only supplied from the short-time storage rather than the long-time storage, thus resulting in a decrease of the voltage of the short-time storage. When the voltage of the short-time storage equals or drops below the voltage of the long-time storage, the electric valve connects the short-time storage in parallel, thereby causing the subsequent supply of the electric machine to be made from both the short-time storage and the long-time storage, whereby the supply current from the long-time storage flows through the electric valve.

According to another aspect, a hybrid drive system comprises a combustion engine, an electric machine, a short-time storage device, and a long-time storage device. The combustion engine and the electric machine are mechanically coupled and arranged to jointly transfer a drive torque to a drive when high performance is required. The drive system is arranged such that the long-time storage and the short-time storage are charged with different charging voltages, whereby the charging voltage of the long-time storage is lower than that of the short-time storage. A down converter providing the lower charging voltage of the long-time storage is connected between the short-time storage and the long-time storage. The short-time storage and the long-time storage are coupled by an electric valve such that, upon a supply of power to the electric machine, the electric machine is initially only supplied from the short-time storage rather than the long-time storage, thus resulting in a decrease of the voltage of the short-time storage. When the voltage of the short-time storage equals or drops below the voltage of the long-time storage, the electric valve connects the short-time storage and the long-time storage in parallel, thereby causing the subsequent supply of the electric machine to be made from both the short-time storage and the long-time storage, whereby the supply current from the long-time storage flows through the electric valve.

According to another aspect, a method is provided of joint application of a drive torque in a hybrid drive system comprising a combustion engine which is mechanically connected with an electric machine, and a short-time storage and a long-time storage coupled with an electric valve. The method comprises charging the long-time storage and the short-time storage with different charging voltages before energy is drawn, in such a way that the charging voltage of the long-time storage is lower than that of the short-time storage; and withdrawing energy to drive the electric machine. Whereby, because of the electric valve, a supply of power to the electric machine is initially only made from the short-time storage rather than the long-time storage, thus causing the voltage of the short-time storage to drop. Whereby the electric valve connects the short-time storage and the long-time storage in parallel when the voltage of the short-time storage equals or drops below the voltage of the long-time storage, resulting in a subsequent supply of power for the electric machine from both the long-time storage and the short-time storage. Whereby the supply current flows from the long-time storage through the electric valve.

According to another aspect, a method is provided of joint application of a drive torque in a hybrid drive system comprising a combustion engine, which is mechanically connected with an electric machine, a short-time storage and a long-time storage coupled with an electric valve, and a down converter coupled from the short-time storage to the long-time storage. The method comprises charging, before energy is drawn, the short-time storage and, by means of the down converter, the long-time storage, resulting in the charging voltage of the long-time storage is lower than that of the short-time storage; and withdrawing energy to drive the electric machine, whereby, because of the electric valve, a supply of power to the electric machine is initially only made from the short-time storage rather than the long-time storage, thus causing the voltage of the short-time storage to drop. Whereby the electric valve connects the short-time storage and the long-time storage in parallel when the voltage of the short-time storage equals or drops below the voltage of the long-time storage, resulting in a subsequent supply of power for the electric machine from both the long-time storage and the short-time storage. Whereby the supply current flows from the long-time storage through the electric valve.

Other features are inherent in the disclosed products and methods or will become apparent to those skilled in the art from the following detailed description of embodiments and its accompanying drawings.

### BRIEF DESCRIPTION OF THE DRAWINGS

Embodiments of the invention will now be described, by way of example, and with reference to the accompanying drawings, in which:

FIG. 1 is a so-called Ragone diagram for different power storage devices;

FIG. 2 is basic wiring diagram of a power storage unit;

FIG. 3 is a wiring diagram similar to FIG. 2, showing the embodiment of a down converter;

FIG. 4 is a basic wiring diagram of a down converter and the voltages and flows resulting from the down conversion;

FIG. 5 is another embodiment of a power storage unit together with a switch to the power supply of an electric machine of a hybrid drive system;

FIG. 6 is an embodiment similar to FIG. 5, whereby an electric valve is actively controlled by an energy management control device;

FIG. 7 is a schematic view of a hybrid drive system;

FIG. 8 is a diagram of the time history of the short-time and the long-time storage devices for low energy power take-off; and

FIG. 9 is a diagram similar to FIG. 8, yet for a higher power take-off.

### DETAILED DESCRIPTION

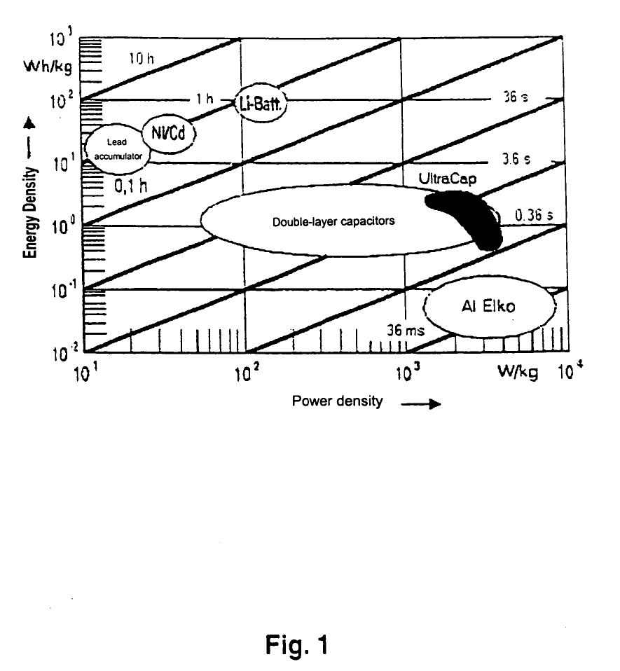

FIG. 1 shows a so-called Ragone diagram (energy density as a function of the power density) for different power storage devices. Below is a detailed explanation of both the “short-time storage” and “long-time storage” based on the diagram. The diagonal lines in the Ragone diagram are isochrones, i.e., lines with the same power take-off time, whereby “power take-off time” refers to the minimum time during which, for example, 97% of the nominal storage energy of an energy storage device can be drawn from said energy storage device. Within the framework of the embodiments, short-time storage devices are those electric energy storage devices with a power take-off time of less than 6 minutes, e.g. 60 seconds, 10 seconds. Within the framework of the embodiments, long-time storage devices, on the other hand, are those electric storage devices with a power take-off time of more than 6 minutes, e.g. 15 minutes, 30 minutes.

The Ragone diagram of FIG. 1 shows examples of possible short-time storage devices comprising a double-layer capacitor, and among these so-called “UltraCaps.” The latter comprise a specially prepared carbon tissue saturated with a highly conductive organic electrolyte. Said UltraCaps are available at Siemens Matsushita Components or EPCOS, for example. Besides capacitors, chemical energy storage devices may also be suitable short-time storage devices for high power take-off, e.g., so-called secondary alkaline systems, nickel/cadmium or nickel/iron alkaline systems, which may contain self-baking electrodes or fiber pattern electrodes, for example. Examples of long-time storage devices with respect to FIG. 1 are electrochemical batteries, such as lithium batteries (i.e., systems composed of lithium ion cells), nickel/cadmium batteries, or lead accumulators. Fuel cells may also be used as long-time storage devices. Some embodiments use UltraCaps for short-time storage and lithium-ion batteries with spiral-shaped cells for long-time storage.

The Ragone diagram of FIG. 1 shows how the double-layer capacitors suitably bridge the gap between the conventional lead accumulator and conventional aluminum-electrolyte capacitors. The storage mechanism of double-layered capacitors consists of a charge transfer at the interface between the electrode and the electrolyte, whereas said electrolyte capacitors use the polarization of a nonconductor to store energy. The available capacitor surface may be considerably enlarged by using active carbon tiles in the UltraCaps, thus allowing to reach energy densities in the range of 20 Wh/kg. The typical take-off times of UltraCaps are between 0.1 seconds to 20 seconds. Depending on the individual electrode structure, several hours will pass until the entire residual charge has been removed. Therefore, the take-off time does not refer to the total nominal storage energy—as mentioned earlier—but only to a part, such as 97%, for example.

The maximum charging/discharging current is merely determined by the interior resistance, keeping unintentional short circuits from disturbing the UltraCap. In this case, the charging mode is exclusively a function of the voltage, but does not depend on different dynamic, chemical, and physical factors, as opposed to electrochemical batteries. The temperature has virtually no influence on the capacity of an UltraCap. It is particular advantageous that several hundreds of thousand charging cycles with a service life of up to 100,000 hours may be realized. Further details about UltraCaps may be found, for example, in the above-mentioned article written by Michel.

In an electrochemical long-time storage, ions are generally transported inside an electrolyte between the anode and the cathode, whereby said ions react electrochemically to the anode or the cathode, causing a corresponding charging or discharging current to flow between the anode and the cathode at the line current. In case of a lithium battery, for example, ions are transported in the electrolyte, whereby the anode is made of carbon, and the cathode of a lithium transition metal oxide. The cathode and the anode present a spiral-shape winding, for example, in order to enlarge the surface. Such lithium-ion cells are sold by the AGM company, for example. For such long-time storage devices, it is basically favorable to keep the battery state of charge (SoC) as high as possible in order to extend the service life.

The state of the art uses either batteries or capacitors for the boost function of hybrid vehicles, or capacitors and batteries connected in parallel for starting combustion engines. If only one battery is used, it should be oversized; this will also shorten the battery life. Said capacitor-battery combinations do not allow the best energetic presentation of long discharge phases. Furthermore, the use of the capacitor storage is usually not as good, i.e., the storage system is relatively expensive.

The embodiments described herein combine the advantages of a short-time storage with those of a long-time storage in a novel way. In the embodiments, the long-time storage is generally not involved in short- to medium-time energy throughput. Most of the energy throughput occurs through the short-time storage. This is realized by selecting a different voltage for both storage devices, and separating them by means of an electric valve. Altogether, this energy storage combination allows for a high bi-directional pulse performance in the short-time range on the one side, and a high bi-directional pulse performance in the minute range with a relatively small construction and relatively long service life of the long-time storage device.

The embodiments therefore combine two technical aspects: charging both storage devices on the one hand, in such a way that the charging voltage of the short-time storage is higher than that of the long-time storage and, on the other hand, the discharge of both storage devices is first drawn from the short-time storage and not from the long-time storage, resulting in a voltage decrease in the short-time storage. When a boost requires so much energy that the voltage of the short-time storage equals or drops below the voltage of the long-time storage, the electric valve will connect both storage devices in parallel and effect the subsequent charging. The subsequent supply of the electric machine is made from both the short-time storage and the long-time storage, whereby the supply current from the long-time storage flows through the electric valve.

In some embodiments, there is a voltage drop (the forward voltage) in the electric valve during transmission operation, which shall be included in the play between the voltages of the short-time and the long-time storage. In those embodiments, the electric valve does not connect both storage devices in parallel until the voltage of the short-time storage equals or drops below the sum of the voltage of the long-time storage and the transmission voltage.

The electric valve of some embodiments is a (high-power) diode, e.g., a Schottky diode. In other embodiments, the electric valve is an electric switch controlled by a control. The control may comprise a voltage sensor, for example, measuring the voltage difference between the short-time and the long-time storage; it opens the electric valve, provided the difference is positive, and closes the electric valve when the difference equals zero or is negative.

As mentioned above, the short-time storage of some embodiments comprises a capacitor storage, and the long-time storage comprises an electrochemical storage. Even though the option of a single capacitor and/or a single electrochemical cell is included, in some embodiments said storage devices of some embodiments are made of parallel and/or serial connections of several capacitors or electrochemical cells.

The long-time storage device may be charged with a lower charging voltage than that of the short-time storage. This may be done in different ways by means of different types of connections. In some embodiments, a down converter is connected between the short-time and the long-time storage, generating the lower charging voltage of the long-time storage from the higher voltage level of the part of the connection in which the short-time storage is located. The down converter may be arranged for lower power requirements, relative to the electric valve (e.g., for less than 20% of the maximum power of the electric valve), since there generally is ample time to recharge the long-time storage, and the maximum charging capacity of many electrochemical storage devices is smaller than the maximum discharging capacity. Besides the down converter, an optional up converter operating in the opposite direction may also be provided. The latter makes it possible to charge a standing combustion engine with the long-time storage when the short-time storage is empty, thus creating an emergency start option, for example, for such embodiments starting the combustion engine by drawing energy from the short-time storage.

In other embodiments, the long-time storage is charged at a lower charging voltage than that of the short-time storage, and the voltage is drawn from a different part of the electrical system, i.e., without the above-mentioned up converter. A down converter or an up converter will then generate the difference in charging voltage between the short-time and the long-time storage, depending on the fact whether the voltage of the other part of the electrical system is higher or lower than that of the long-time storage. In said embodiments, the connection with the short-time storage is only indirectly present due to the fact that the short-time storage is also connected with the other part of the electrical system by means of a suitable up or down converter.

In some embodiments, the electric machine is a rotary field machine, controlled by a direct current intermediate circuit current inverter. In those embodiments, the short-time storage is connected in the intermediate circuit of the current inverter. Consequently, the energy drawn from the short-time storage flows directly into the current inverter, i.e., is available for the electric machine in the most direct way (by intermediately connecting the current inverter).

Some embodiments comprise not only a short-time storage and a long-time storage, but also an additional long-time storage, which is called an “electrical system long-time storage.” This may be, for example, a conventional lead-sulfuric acid accumulator. This means that the long-time storage of these embodiments is not the same one as the conventional electrical system, but an additional long-time storage whose only task is to support the short-time storage, in particular when the electric machine requires a long torque support, or when starting the combustion engine. However, in certain cases of said embodiments, it is not intended to supply other consumers in the electrical system, since this is rather done by the battery of the electrical system. The system of these embodiments is a three-storage system, having three storage devices at different voltage levels. The intermediate circuit voltage level of the short-time storage could, for example, be set between 21 and 48 volts, the long-time set at 24 volts, and the electrical system set at 12 volts. In the embodiments with an intermediate circuit current inverter, the electrical system long-time storage is connected with the intermediate circuit by means of a down converter.

In some embodiments, the electric machine is seated on, and permanently connected with the crankshaft of the combustion engine. In some embodiments, a step-up or a step-down gear (e.g., in the form of a planetary gear) has been connected between the crankshaft and the armature of the electric machine. In other embodiments, the connection of the armature of the electric machine and the crankshaft may be torque proof, i.e., it permanently rotates at the same rotary frequency as the combustion engine.

In some embodiments, the electric machine not only serves as a booster, but also as a direct starter for the combustion engine, i.e., it can start the combustion engine from the support with the same rotary frequency as the combustion engine. Furthermore, the electric machine of some embodiments serves as a generator charging the short-time and long-time storage, as well as an electrical system long-term storage, if available, and consumers. In the case of a synchronous machine operating as a generator, no excitation is required and the current inverter only needs to operate as a rectifier. In the case of an asynchronous machine, the current inverter also generates phase-alternate current when operating as a generator. As opposed to engine mode, however, these phase alternate currents lag in phase relative to the rotation of the armature (so-called negative slippage), meaning that the electric machine operates as a braking generator. Electric machines with a starter and generator function, which are seated on the crankshaft, are also known as “crankshaft-starter-generators.”

In some embodiments, the hybrid drive system is designed in such a way that the electric machine can also operate as a recovery brake when the vehicle brakes are activated. The electric energy recovered from the recovery brake action is at least in part stored in the short-time storage, allowing for a relatively high brake performance because of its short-time aspect. It can stay there and be re-used during later boost operations, or may be used after the recovery brake operation to recharge (relatively slowly) the long-time storage and/or, if available, the long-time storage of the electrical system.

The above and following discussion of the hybrid drive system applies in the same way to the embodiments of the method of a joint application of a drive torque, which will therefore not be repeated.

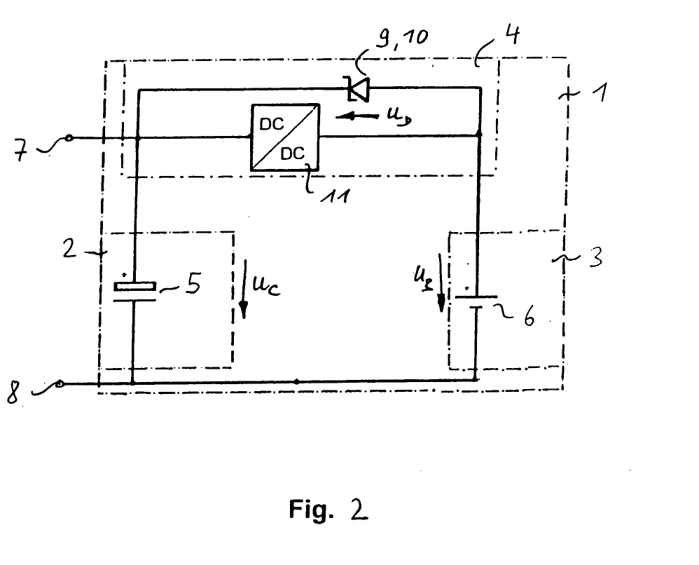

Returning to the figures, FIG. 2 is a basic wiring diagram of a power storage unit 1 of an embodiment of the hybrid drive system. It also includes a short-time storage 2 and a long-time storage 3, connected by means of a coupling element 4. The short-time storage 2 of some embodiments comprises one or several UltraCaps 5. The long-time storage 3 of some embodiments comprises a battery 6 with a plurality of lithium-ion cells. The coupling element 4 connects the positive pole of the long-term storage 3 with the positive pole of the short-time storage 2. The power storage unit 1 presents exterior clamps 7 and 8, transmitting energy to the power storage unit 1 when charging and removing energy from the power storage unit 1 during discharging. One exterior clamp 7 is connected with the positive pole of the short-time storage, and the other exterior clamp 8 is connected with the negative pole of the storage devices 2, 3. The coupling element 4 is created by a parallel connection of an electric valve 9, e.g., a diode 10 and a down converter 11. The transmission or blocking nature of the diode 10 depends on the diode voltage U_{D} of the diode. This is the difference between the voltage U_{B} at the battery 6 and the voltage U_{C} at the UltraCap 5. As for the switch nature of the diode, it can be assumed by approximation that it switches through when the diode voltage U_{D} is larger than the forward voltage U_{FD} of the diode 10, and blocks in the opposite case.

When the power storage unit is being charged, U_{C} always exceeds U_{B}, meaning that the diode 10 blocks, i.e., only the down converter 11 operates in the coupling element 4.

When the power storage unit is being discharged, on the other hand, a case differentiation is made regarding the voltage difference between U_{C} and U_{B}. As long as the blocking condition U_{C}>U_{B}−U_{FW} is true, the diode 10 blocks, resulting in the fact that the power storage unit 1 is only discharged through the exterior clamps 7, 8 only from the UltraCap 5. The U_{C} voltage drops during this discharge process until the above-mentioned blocking condition is no longer met, resulting in the diode 10 letting through and the UltraCap 5 and the battery 6 being connected in parallel via the diode 10. The down converter 11 is deactivated during the discharge, making the total power of the UltraCap 6 available at the exterior clamps 7, 8 when the diode 10 is blocked. The diode 10 bridges the down converter 11 as soon as the diode 10 switches to transmission.

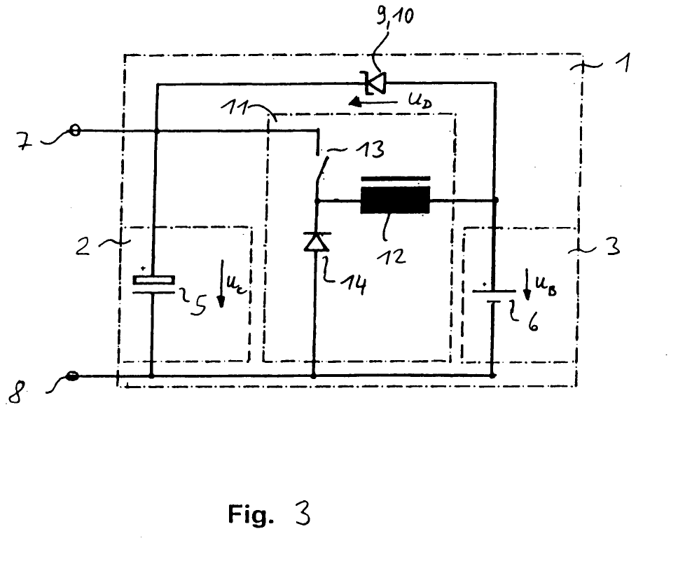

FIG. 3 is a wiring diagram similar to FIG. 2, showing the embodiment of a down converter, comprising a storage inductor 12, a power switch 13 and a diode 14—hereinafter called “down converter switch” or “down converter diode.” The power switch 13 and the down converter diode 14 are switched in series and located between the input with a higher voltage of the voltage converter 11 and the negative exterior clamp 8. The storage inductor 12 is positioned between the power switch 13 and the down converter diode 14 and the positive pole of the battery 6.

The charging cycle of the energy storage part of FIG. 3 will now be described first. The electric valve 9 is closed, i.e. it does not serve any purpose in the charging cycle. First, the UltraCap 5 is directly charged from the present voltage U_{C} (e.g., 48V) at the exterior clamps 7, 8. The down converter 11 reduces this voltage to the lower charging voltage U_{B} (e.g., 48V) of the battery 6. The extent of the reduction results from the test relation of the power switch 13. Due to the internal resistance of the battery 6, the voltage at its clamps is slightly lower after the charging process than the charging voltage, e.g., 24V for a charging voltage of 28V.

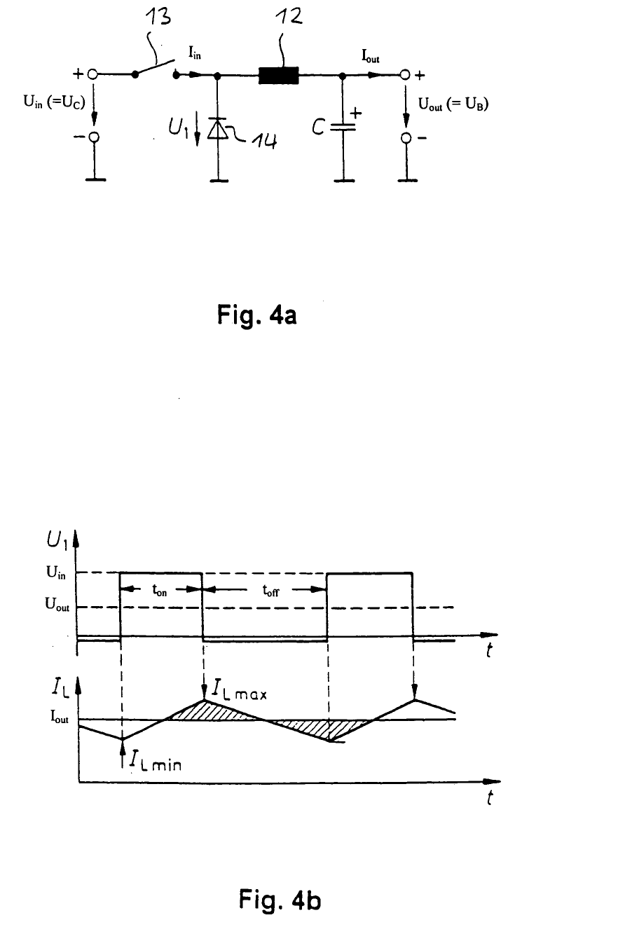

FIGS. 4a and 4b illustrate the operation of the down converter 11 of FIG. 3, whereby FIG. 4a shows a basic wiring diagram, and FIG. 4b shows the resulting voltages and currents. As long as the switch 13 is closed, the input voltage U_{S} is present at the down converter diode 14, thus locking the down converter diode. A current flows through the storage inductor 12. The size of said flow slowly increases and is limited under the influence of the storage inductor 12. When the switch 13 opens, the current through the storage inductor 12 continues to flow in the same direction, whereby the down converter diode 14 becomes conductive. In this stage, the current slowly decreases. The capacity of the battery 6 takes over the function of the filter capacitor C shown in FIG. 4a. Therefore, the following mean output voltage Uₒᵤₜ results from the test relation of the switch 13:

Uₒᵤₜ=tᵢₙ/(tᵢₙ+tₒᵤₜ)×Uᵢₙ

In the example shown in FIG. 4b, the test relation is so large that the voltage does not drop to zero. In the case of smaller test relations, the inductor current drops when the switch 13 is blocked, causing the down converter diode 14 to block and the voltage at the inductor to drop to zero.

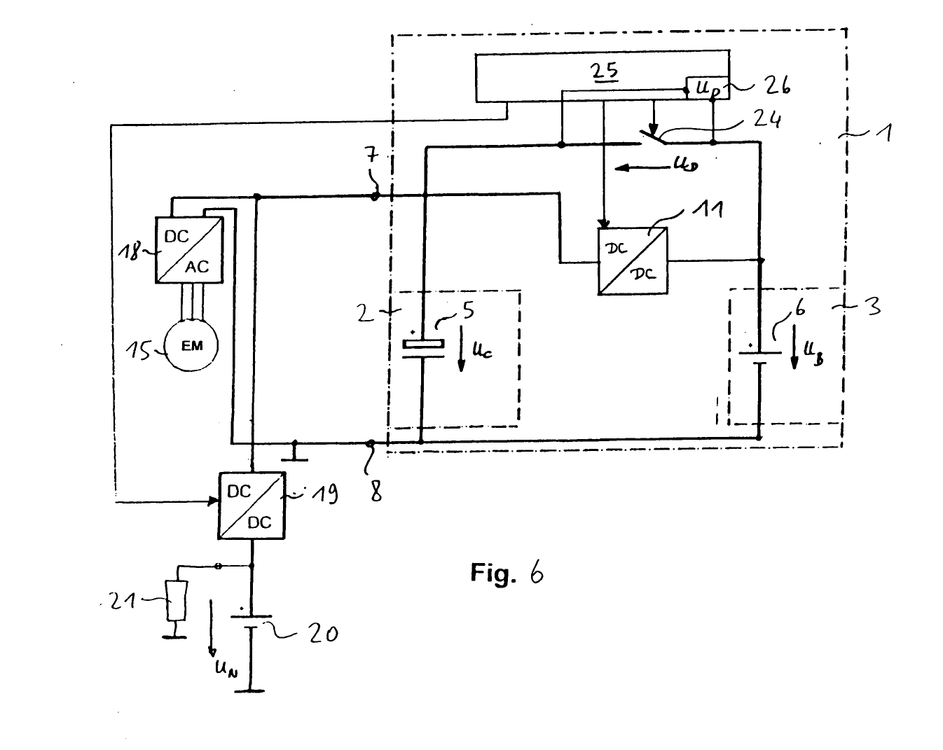

In other embodiments, the down converter operates by means of a so-called surge charge. For this purpose, it is designed as a switch between the UltraCap 5 and the battery 6, and closed long enough in order to arrange for the return charge of the battery 6 until the maximum battery charge is reached at the battery (a control apparatus of said switch receives readings of the battery voltage). This results in a charging surge from the UltraCap 5 in the battery 6. If need be, this cycle may be repeated several times to recharge the battery 6. Said surge down converter is especially advantageous for the embodiment of FIG. 6 explained in further detail below, whereby the electric valve 9 comprises a controlled electric switch 24. This (bi-directional) switch 24 can also operate as a switch of the surge down converter, provided the suitable control in the sense of the above description is available. The down converter 11 indicated in FIG. 6 with a separate symbol “11” may be omitted since the switch 24 and the control apparatus 25 take over its function.

Returning to FIG. 3 now, the down converter 11 is inactive when the battery 6 does not need to be charged. This is done by permanently keeping the power switch 13 opened. This especially applies to the discharge cycle of power storage unit 1 described below.

First of all, during the discharge cycle the blocking condition U_{C}>U_{B}−U_{FD} is met, so that the diode 10 is blocked. In this condition, the power storage unit 1 is only discharged from the UltraCap 5. During the discharge process, the voltage U_{C} of the UltraCap 5 drops. If the voltage drops to the extent that the above-mentioned condition is no longer being met, or—in other words—in the case of U_{C}<U_{B}−U_{FD}, the diode 10 switches through, resulting in the UltraCap 5 and battery 6 being switched in parallel (whereby the slight transmission resistance of the 10 is being ignored). Since the voltage characteristic of the battery 6 is basically constant in comparison with the UltraCap 5, the battery 6 now supplies most of the energy released to the exterior clamps.

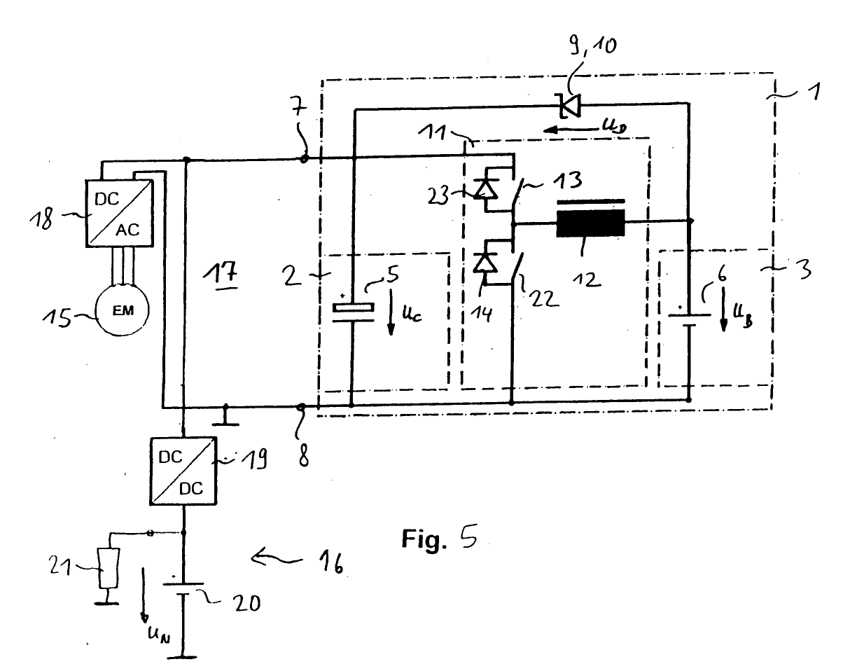

FIG. 5 shows another embodiment of the power storage unit 1 together with a circuit for supplying an electric machine 15 of a hybrid drive system, as well as an electrical system 16 for a vehicle equipped with said drive system. The exterior clamps 7, 8 are actually connected with a direct current intermediate circuit 17 of a current inverter 18. This generates three-phase alternate currents charging the electric machine 15 (an asynchronous rotary current machine in this case) with the assistance of a sinus-rated pulse-width modulation from the direct current of the intermediate circuit 17, for example. The three-phase alternate current can be generated with any frequency, phase, and amplitude (within certain boundaries), making it possible to operate the electric machine 15 with a variable rotary frequency and rotary torque both as a motor and a generator.

Furthermore, the electric system 16 is connected with the intermediate circuit 17 by means of an electric system inverter 19. This lowers the higher intermediate circuit voltage (e.g., variably in the range of 21 to 48 Volt) to the lower voltage level (electrical system U_{N}) of the electrical circuit 16 (which is at 14 Volt, for example). In come embodiments, the electrical system inverter 19 is a bi-directional inverter, which also allows energy to flow out of the electrical system 16 in the intermediate circuit 17 and raises the lower electrical system voltage to the higher intermediate circuit voltage. The electrical system 16 comprises an electrical circuit battery 20, e.g., a conventional lead-sulfuric acid battery. The electrical system 16 is basically intended to supply power to electric consumers 21 in the vehicle. The battery 20 of the electrical system comprises an emergency running mode, whereby consumers 21 (e.g., vehicle lights) continue to operate when the electrical system converter 19 breaks down. In embodiments in which the electrical circuit converter 19 is also designed as an up converter in the intermediate circuit 17, energy can also be drawn from the battery 20 of the electrical system and supplied to the intermediate circuit 17, e.g., in order to charge the short-time storage 2.

In the embodiment of FIG. 5, the coupling element 4 is also designed as an up converter. To this end, it comprises an up converter switch 22 switched in parallel with the down converter diode, as well as an up converter diode 23 switched in parallel with the down converter switch 13. The up converter mode of the coupling element 4 is created by clocking the up converter switch 22 while keeping the down converter switch 13 opened. Analogous to the description of the down conversion of FIG. 4, the voltage U_{C} at the UltraCap 5 depending on the voltage U_{B} at the battery 6 results as U_{C}=(tᵢₙ+tₒᵤₜ)/tₐᵤₛ×U_{B}.

FIG. 6 shows another embodiment, whereby the electric valve 9 is created by a electric power switch 24, which is actively controlled by an energy management control device 25. The control device 25 comprises a sensor 26 detecting the voltage difference between the UltraCap voltage U_{C} and the battery voltage U_{B}. As long as the voltage difference remains positive, the control device 25 keeps the power switch 24 open. As soon as it reaches zero or becomes negative, it closes the power switch 24 and thus switches the UltraCap 5 and the battery 6 in parallel. Following FIG. 6, the energy management control apparatus 25 also controls the down and up voltage converter 11 (designed following FIG. 5) and the electrical system converter 19. It should be noted that the embodiment of FIG. 5 also comprises a corresponding energy management control apparatus for the control of the converters 11 and 19. As opposed to FIG. 6, the control apparatus does not have to provide for the active voltage dependent parallel switch of short-time storage 2 and long-time storage 3 devices, since a valve which is self-controlled by the voltage difference, i.e., the diode 10, is used for the electric valve 9.

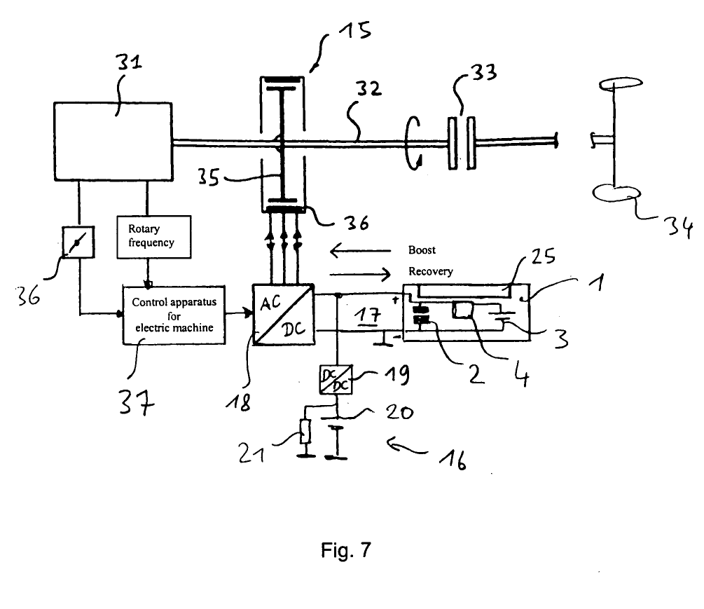

FIG. 7 is a schematic view of a hybrid drive system comprising the switch arrangement of FIGS. 5 or 6. The drive system actually comprises a combustion engine 31 transmitting the torque via a driveshaft 32 (e.g., the crankshaft), a coupling 33 and other parts (not shown) of a drive rod (which may comprise a gear shift drive, for example) to the drive wheel 34 of the vehicle equipped with the drive system. When more power is required, the electric machine 15 rests on the driveshaft 32 and supports the combustion engine 31 by transmitting drive torque to the driveshaft 32 (this function is also called the “boost function”). The electric machine 15 also serves as a starter for the combustion engine. Because it can be switched from motor to generator mode, it can also serve as a generator charging the energy storage unit 1 and the battery 20 of the electrical system, and feed the electrical system consumers 21 while the combustion engine 31 runs—provided no booster function is required. The electric machine 15 also serves as a recovery break when the brake system of the vehicle is activated. To this end, the electric energy recovered from the recovery brake during generator mode is stored in the short-time storage 2. The electric machine 15 is an asynchronous rotary current machine or—in other embodiments—a synchronous rotary machine with permanent magnets. It comprises an armature 35, which is directly seated on, and permanently connected with the driveshaft 32, as well as a support 36 propped under the enclosure of the combustion engine 31. Said support 36 comprises a poly-phase winding (e.g., a three-phase winding) and is powered through the current inverter 18 by means of electric currents and voltages of random variable amplitude, frequency and phase. The current inverter 18 is connected with the power storage unit 1 and the electrical system 16 with the electrical system converter 19 via the intermediate circuit 17, as shown in FIGS. 5 or 6.

The combustion engine 31 comprises a load sensor 36 delivering a signal representing the load or power requirement at that time at the combustion engine 31. This could be determined, for example by the position of the throttle valve of the combustion engine 31 and/or the pressure in the aspiration system behind the throttle valve. The smaller the opening of the throttle valve or the lower the pressure behind the throttle valve, for example, the greater the load. Based upon the information provided by the load sensor 36, a control apparatus 37 for the electric machine 15 decides whether and to which extent the electric machine 15 should develop a boost effect for the combustion engine 31. This decision may also include other data relating to the operating condition of the combustion engine 31 (e.g., the rotary frequency) and the load condition of the energy storage unit 1. If the driver of the vehicle would like to accelerate a lot or drive up a relatively steep slope, he will push down the drive pedal of the vehicle relatively deep, relative to the rotary frequency of the combustion engine at that time. The load sensor 36 then detects the presence of a relatively high load, e.g., because of a relatively small aspiration system pressure behind the throttle valve, and transmits this to the control apparatus 37. When taking into consideration the information that the rotary frequency of the combustion engine is relatively low at that time, the machine control apparatus 37 decides that the electric machine 15 needs to provide a boost support, upon which the current inverter 18 is activated accordingly. The energy discharge from the power storage unit 1 and the possible switching in parallel of the short-time storage 1 and the long-time storage in those embodiments whereby the electric valve 9 is a self-controlled valve controlled by the voltage difference (e.g., a diode), may occur without exterior controlling intervention. In the embodiments of FIG. 6, on the other hand, the electric valve 9 is actively controlled by the energy management control apparatus 25 in such a way that it possibly creates said parallel switch.

If no boost function is required and the machine control apparatus 37 determines at the same time that electric energy is needed, which is indicated, for example, by lowering the voltage in the intermediate circuit 17 below a threshold value of, e.g., 40 volts, the machine control apparatus 37 occasions the current inverter 18 to generate voltages suitable for generator mode. The current inverter 18 redresses the currents created inside the machine 15 during generator mode and the currents are supplied to the intermediate circuit 17. The energy management control apparatus 25, which is also included in the embodiment of FIG. 5, then controls the down converter 11 and/or the electrical system converter 19 in such a way that they lower the relatively high intermediate circuit voltage to 28V or 14V, for example, resulting in the long-time storage 3 or the electrical system battery 20 being charged and the consumers 21 being powered. In case the vehicle brakes need to be activated, which may be detected by means of a brake pedal sensor, for example, and the short-time storage 2 is not fully charged, i.e., may still accept recovered energy, which is determined by measuring the voltage U_{C}, for example, the machine control apparatus 37 occasions the current inverter 18 to generate the voltages and currents for the generator recovery brake and suitable for the desired brake effect of the generator. The currents recovered from the recovery brake action are redressed by the current inverter 18 and supplied to the intermediate circuit 17 in such a way that the recovered energy is stored in the short-time storage 2. The arrows in FIG. 7 indicate the direction of the energy currents in the boost and recovery cycle.

Another function of the electric machine 15 is to start the combustion engine 31. Just like for the boost function, the necessary electric energy is drawn from the energy storage part 1. To this purpose, the energy management control apparatus 25 first verifies whether the short-time storage 2 is sufficiently charged, e.g., by measuring the voltage U_{C}. If not, the control apparatus 25 will occasion recharging of the short-time storage 2 before starting the engine. This will be done via the voltage transformer 11 (which can also be operated as an up transformer) or the electrical system converter 19. Once the storage has been charged, the machine control apparatus 37 occasions the currency inverter 18 to supply suitable currents and voltages for starting the electric machine 15. The energy stored in the short-time storage 2 will generally suffice to start the engine, meaning that the voltage U_{C} will not drop to the point that the short-time storage 2 and the long-time storage 3 have to be connected in parallel. In case of a “long start” (e.g., at extremely low temperatures or in case of starting problems), the parallel connection condition may still be activated and the long-time storage 3 will aid the starting process by supplying energy, thus increasing the security of the starting process.

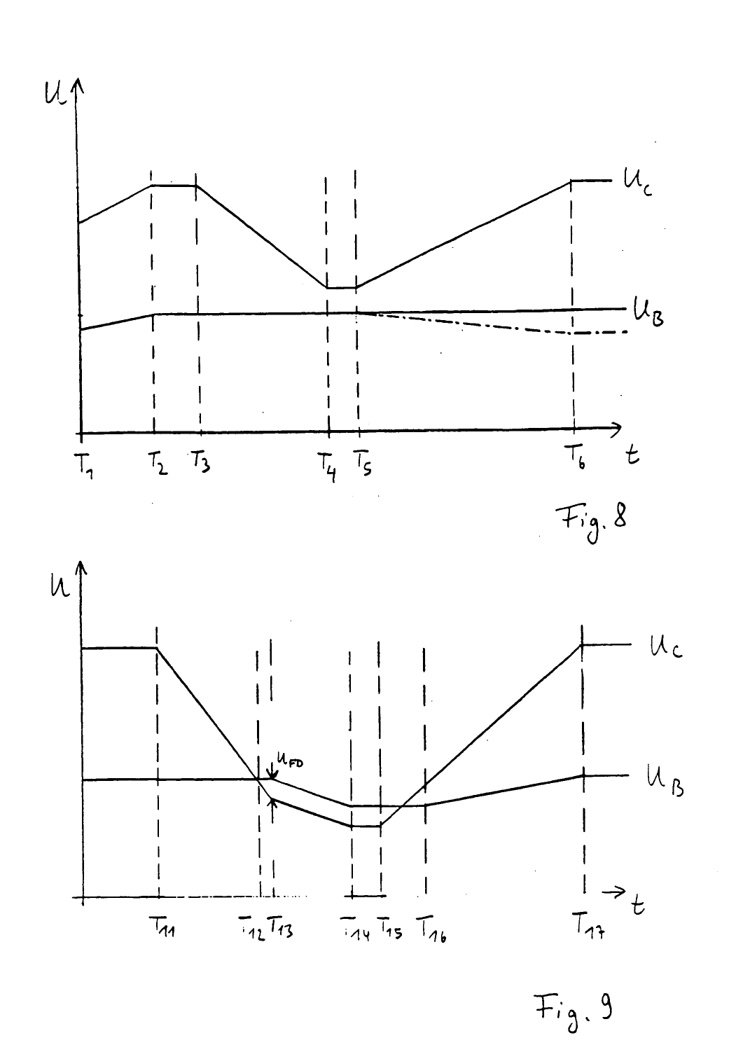

FIG. 8 shows an example of the time history of U_{C} and the U_{B} voltages in case both storage devices 2 and 3 are charged first and subsequently only little energy is required, whereby the long-time storage 3 is not required to supply energy. In the time frame between T₁ and T₂, the short-time storage 2 and then the long-time storage 3 are charged with the respective nominal voltage, for which the electric machine 15 (operating as a generator) supplies the necessary energy. Due to the final internal resistance of the storage devices 2 and 3, the charging voltages are slightly higher than the voltages U_{C} or U_{B} occurring after the charging cycle (i.e., after T₂). This can be neglected though due to the extremely small internal resistance of the short-time storage 2. The charging voltage of the long-time storage 3, however, is typically 10 to 20% higher than the clamp voltage present after the charging cycle due to the relatively higher internal resistance of said storage 3. At time T₃, the driver pushes the accelerator pedal in order to accelerate the vehicle. In order to support the combustion engine during the subsequent acceleration of the vehicle, the electric machine 15 is switched to engine mode. The necessary electrical energy is drawn from the energy storage unit 1. The acceleration ends at T₄. During the acceleration, the voltage U_{C} of the short-time storage drops since energy is drawn; in the example of FIG. 8, it will not drop below the voltage U_{B} of the long-time storage 3. Therefore, the storage devices 2 and 3 will not be connected in parallel, which means that no energy will be drawn from the long-time storage 3, and the voltage of said storage 3 remains unchanged. After accelerating the vehicle, the electric machine 15 is switched back into generator mode. The short-time storage 2 is recharged in the T₅-T₆ timeframe.

The dotted line in FIG. 8 marks the scenario in which the short-time storage 2 is charged by the long-time storage, whereby it is assumed that the short-time storage 2 is only partially discharged and not the long-time storage 3, which is the case at T₅. This may occur, for example, when the combustion engine is stopped immediately after a discharge of the short-time storage 2, or the short-time storage has discharged itself during an extended rest period. In this case, the short-time storage 2 is recharged by drawing energy from the long-time storage 3, thus lowering the voltage U_{B} in the long-time storage 3 (see dash-dotted line between T₅ and T₆ in FIG. 8).

FIG. 9 shows voltage curves of voltage U_{C} and U_{B}, yet for a higher power take-off involving the long-time storage 3, e.g., for a higher acceleration or a longer slope. Both energy storage devices 2 and 3 would first have been charged to nominal voltage. The energy take-off starts at T₁₂, first again only from the short-time storage 2, of which the voltage drops accordingly. At T₁₂, the voltage U_{C} of the short-time storage 2 drops to the voltage U_{B} of the long-time storage 3. The storage devices 2 and 3 are not yet connected in parallel at this point; this occurs at T₁₃ when the voltage U_{C} is reduced by the transmission voltage U_{DL} of the electric valve 9 in comparison with the voltage U_{B} of the long-time storage 3. From that point, the voltages U_{C} and U_{B} drop together, whereby the increase of the voltage drop is smaller than when energy is only drawn from the short-time storage 2 due to the parallel connection and the flat voltage drop characteristic of the long-time storage (here assumed to be an electrochemical storage device). The energy take-off from the energy storage unit 1 ends at T₁₄. At T₁₅, the electric machine 15 switches back into generator mode and starts recharging the short-time storage 2. At T₁₆, the recharging process of the long-time storage 3 starts when the voltage at U_{C} exceeds the actual voltage U_{B}, and actually at a lower charging voltage than that of the short-time storage 2, until T₁₇ when both storage devices 2, 3 have been recharged to the nominal voltage. The simultaneous conclusion of the recharging cycle of both storage devices is only for reasons of simplification of the drawings. The recharge of the long-time storage 3 generally takes longer than that of the short-time storage, in particular when a low-performance down converter 11 is used. In other embodiments, in which the long-time storage 3 is not directly recharged from the intermediate circuit but rather from the electrical system, the charging voltage of the long-time storage 3 may occasionally exceed that of the short-time storage 2, e.g., when it has been discharged at a lower voltage than the long-time storage 3 (as shown in FIG. 9). In these embodiments, however, the charging voltage of the short-time storage 2 exceeds that of the long-time storage 3 at least at the end of the charging cycle.

The embodiments provide for a hybrid drive system with a boost function allowing for a relatively economical design and long service life of the energy storage units. All publications and existing systems mentioned in this specification are herein incorporated by reference.

Although certain products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A hybrid drive system, comprising:
a combustion engine;
an electric machine;
a short-time storage device;
a long-time storage device;
wherein the combustion engine and the electric machine are mechanically coupled and arranged to jointly apply a drive torque to a drive when high performance is required;
wherein the drive system is arranged such that the long-time storage and the short-time storage are charged with different charging voltages, wherein the charging voltage of the long-time storage is lower than that of the short-time storage;
wherein the short-time storage and the long-time storage are coupled by an electric valve such that, upon a supply of power to the electric machine, the electric machine is initially only supplied from the short-time storage rather than the long-time storage, thus resulting in a decrease of the voltage of the short-time storage, and that, when the voltage of the short-time storage equals or drops below the voltage of the long-time storage, the electric valve connects the short-time storage in parallel, thereby causing the subsequent supply of the electric machine to be made from both the short-time storage and the long-time storage, wherein the supply current from the long-time storage flows through the electric valve.

2. The hybrid drive system of claim 1, wherein the electric valve comprises a diode.

3. The hybrid drive system of claim 1, wherein the electric valve comprises an electric switch controlled by a control.

4. The hybrid drive system of claim 1, wherein the short-time storage comprises a capacitor storage.

5. The hybrid drive system of claim 1, arranged such that the charging voltage of the long-time storage does not exceed 65% of the charging voltage of the short-time storage.

6. The hybrid drive of claim 1, wherein a down converter reducing the charging voltage of the long-time storage is connected between the short-time storage and the long-time storage.

7. The hybrid drive system of claim 1, wherein the electric machine is a rotary field machine controlled by a current inverter with a direct current intermediate circuit, and the short-time storage is connected in the intermediate circuit.

8. The hybrid drive system of claim 1, comprising not only the short-time storage and said long-time storage, but also an additional electrical system long-time storage.

9. The hybrid drive system of claim 7, comprising not only the short-time storage and said long-time storage, but also an additional electrical system long-time storage, and wherein the electrical system long-time storage is connected with the intermediate circuit by means of a down converter.

10. The hybrid drive system of claim 1, wherein the electric machine is seated on the crankshaft of the combustion engine and is permanently connected with it.

11. The hybrid drive system of claim 1, wherein the electric machine permanently rotates at the same rotary frequency as the combustion engine.

12. The hybrid drive system of claim 11, wherein the electric machine is also designed as a direct starter.

13. The hybrid drive system of claim 1, wherein the electric machine is also designed as a generator.

14. The hybrid drive system of claim 13, which is arranged such that the electric machine also functions as a recovery brake, wherein the electric energy recovered from the recovery brake process is at least in part stored in the short-time storage.

15. A hybrid drive system comprising:
a combustion engine;
an electric machine;
a short-time storage device;
a long-time storage device;
wherein the combustion engine and the electric machine are mechanically coupled and arranged to jointly transfer a drive torque to a drive when high performance is required;
wherein the drive system is arranged such that the long-time storage and the short-time storage are charged with different charging voltages, wherein the charging voltage of the long-time storage is lower than that of the short-time storage;
wherein a down converter providing the lower charging voltage of the long-time storage is connected between the short-time storage and the long-time storage;
wherein the short-time storage and the long-time storage are coupled by an electric valve such that, upon a supply of power to the electric machine, the electric machine is initially only supplied from the short-time storage rather than the long-time storage, thus resulting in a decrease of the voltage of the short-time storage, and that, when the voltage of the short-time storage equals or drops below the voltage of the long-time storage, the electric valve connects the short-time storage and the long-time storage in parallel, thereby causing the subsequent supply of the electric machine to be made from both the short-time storage and the long-time storage, wherein the supply current from the long-time storage flows through the electric valve.

16. A method of joint application of a drive torque in a hybrid drive system comprising a combustion engine which is mechanically connected with an electric machine, and a short-time storage and a long-time storage coupled with an electric valve, comprising:
charging the long-time storage and the short-time storage with different charging voltages before energy is drawn, in such a way that the charging voltage of the long-time storage is lower than that of the short-time storage;
withdrawing energy to drive the electric machine, whereby, because of the electric valve, a supply of power to the electric machine is initially only made from the short-time storage rather than the long-time storage, thus causing the voltage of the short-time storage to drop, and whereby the electric valve connects the short-time storage and the long-time storage in parallel when the voltage of the short-time storage equals or drops below the voltage of the long-time storage,
resulting in a subsequent supply of power for the electric machine from both the long-time storage and the short-time storage, whereby the supply current flows from the long-time storage through the electric valve.

17. A method of joint application of a drive torque in a hybrid drive system comprising a combustion engine, which is mechanically connected with an electric machine, a short-time storage and a long-time storage coupled with an electric valve, and a down converter coupled from the short-time storage to the long-time storage, comprising:
charging, before energy is drawn, the short-time storage and, by means of the down converter, the long-time storage, resulting in the charging voltage of the long-time storage being lower than that of the short-time storage;
withdrawing energy to drive the electric machine, wherein, because of the electric valve, a supply of power to the electric machine is initially only made from the short-time storage rather than the long-time storage, thus causing the voltage of the short-time storage to drop, and whereby the electric valve connects the short-time storage and the long-time storage in parallel when the voltage of the short-time storage equals or drops below the voltage of the long-time storage, resulting in a subsequent supply of power for the electric machine from both the long-time storage and the short-time storage, wherein the supply current flows from the long-time storage through the electric valve.
